(19) United States
(12) Patent Application Publication
(10) Pub. No.: US 2024/0359474 A1
(43) Pub. Date: Oct. 31, 2024

(54) LIQUID SUPPLY APPARATUS

(71) Applicant: CANON KABUSHIKI KAISHA, Tokyo (JP)

(72) Inventors: RYOHEI MARUYAMA, Kanagawa (JP); HIROMASA YONEYAMA, Kanagawa (JP); MASAKAZU NAGASHIMA, Kanagawa (JP); KENTA IIMURA, Kanagawa (JP); YUJIRO ISHIDA, Tokyo (JP); KOHEI FUKUI, Tokyo (JP); SHU KURIHARA, Tokyo (JP)

(21) Appl. No.: 18/639,700

(22) Filed: Apr. 18, 2024

(30) Foreign Application Priority Data
Apr. 28, 2023 (JP) 2023-074955

(51) Int. Cl. B41J 2/175

(52) U.S. Cl. CPC B41J 2/17503; B41J 2/17566

(57) ABSTRACT

A liquid supply apparatus includes a holding member and a receiving member. The holding member detachably holds a tray on which a container, that is flexible and is provided with a supply port for supplying liquid to a recording head, is placed with respect to the liquid supply apparatus. The receiving member is provided below the holding member attached to the liquid supply apparatus and receives a liquid leaking from the container. An angle of a bottom surface of the holding member with respect to a horizontal plane is different from an angle of a bottom surface of the receiving member with respect to the horizontal plane.

### BACKGROUND

### Field

The present disclosure relates to a liquid supply apparatus that supplies liquid to a printing apparatus.

### Description of the Related Art

Regarding a large size inkjet printer, a known ink supply apparatus has a flexible bag-shaped ink tank that is set up on a tray, and the tray that is attached from a lateral direction of the apparatus. The bag-shaped ink tank is crushed at the flexible bag part along with consumption of ink. At this time, if the flexible bag part near an ink supply port is completely crushed, the ink cannot be supplied from the ink tank, and the ink cannot be used any more.

Japanese Patent Laid-Open No. 2021-017022 discloses a technique of, by attaching an ink tank in an inclining position and disposing a supply port at a lowermost end of the inclination, flowing ink in the ink tank near the supply port by gravity, and improving the use-up property of the ink.

However, the configuration as described above has a possibility that when the ink leaks from the ink tank, the supply port, and the like, the ink goes down along the inclined part, drops downward by gravity, drips to the bottom surface, and leaks out of the apparatus from a corner part, a screw fastening part, or the like.

### SUMMARY

Disclosed is a liquid supply apparatus having features that prevent liquid from leaking out of a liquid supply apparatus.

According to an aspect of the present disclosure, a liquid supply apparatus includes a holding member configured to detachably hold a tray on which a container, that is flexible and is provided with a supply port for supplying liquid to a recording head, is placed with respect to the liquid supply apparatus, and a receiving member that is provided below the holding member attached to the liquid supply apparatus and is configured to receive a liquid leaking from the container, wherein an angle of a bottom surface of the holding member with respect to a horizontal plane is different from an angle of a bottom surface of the receiving member with respect to the horizontal plane.

Further features of the present disclosure will become apparent from the following description of exemplary embodiments with reference to the attached drawings.

### BRIEF DESCRIPTION OF THE DRAWINGS

FIG. 1 is a perspective view of a printing apparatus and a liquid supply apparatus.

FIGS. 2A and 2B are a front view and a side cross-sectional view of the printing apparatus and the liquid supply apparatus.

FIGS. 3A to 3C are a perspective view and side views of the liquid supply apparatus.

FIGS. 4A and 4B are enlarged views of a cam.

FIG. 5 is an explanatory view of a tray holding unit in the liquid supply apparatus.

FIG. 6 is a perspective view of the tray holding unit.

FIG. 7 is a plan view illustrating a configuration of an ink receiving member.

FIGS. 8A and 8B are explanatory views of an ink guide path of the tray holding unit.

FIG. 9 is a flowchart showing the operation of the liquid supply apparatus after ink detection.

FIG. 10 is an explanatory view illustrating another form of the ink receiving member.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made that requires all such features, and multiple such features may be combined as appropriate. Furthermore, in the attached drawings, the same reference numerals are given to the same or similar configurations, and redundant description thereof is omitted.

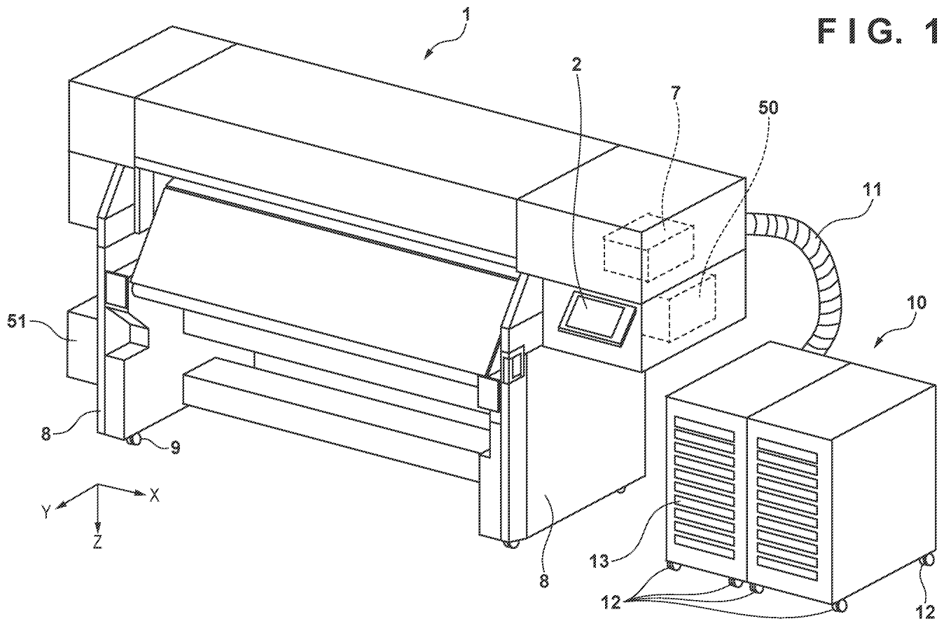

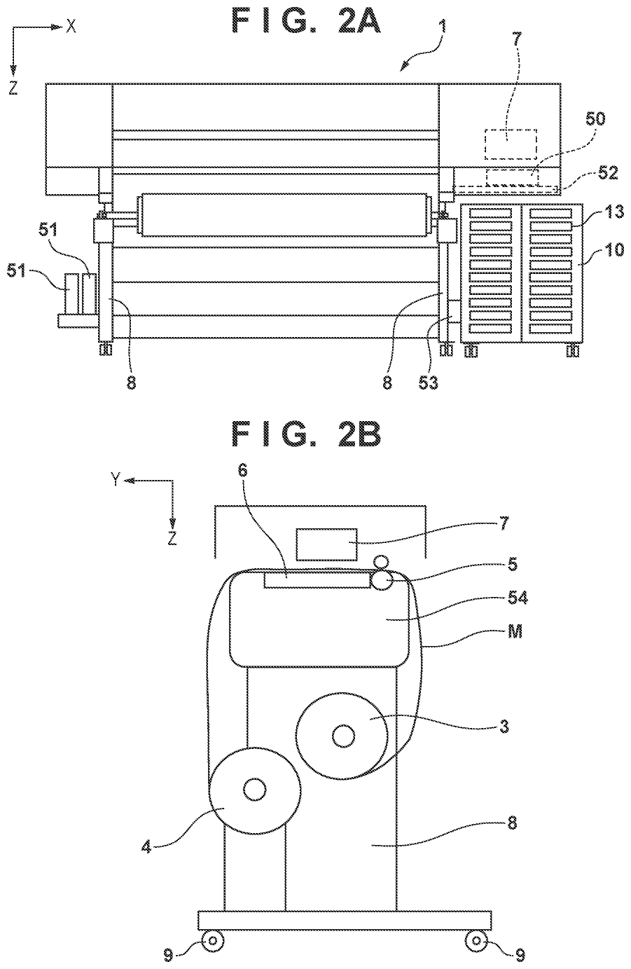

FIG. 1 is a perspective view of a printing apparatus and a liquid supply apparatus connected to the printing apparatus according to one embodiment of the present disclosure. FIGS. 2A and 2B are a front view and a side cross-sectional view of the printing apparatus and the liquid supply apparatus.

The present embodiment is described with the left-right direction when a printing apparatus 1 is installed on a horizontal plane defined as an X direction, the anterior-posterior direction as a Y direction, and the top-bottom direction as a Z direction. The right side when the printing apparatus 1 is viewed from the front is defined as a +X direction, the left side as a −X direction, the front side as a +Y direction, the rear side as a −Y direction, the lower side (downward in the direction of gravity) as a +Z direction, and the upper side as a −Z direction.

In the printing apparatus 1, a housing 54, a paper feed unit 3, and a winding unit 4 are installed on a stand 8 attached with a caster 9. In the housing 54, units related to printing such as a conveyance unit 5, a platen 6, a recording head 7, and a recovery unit 50 are disposed. A recording medium M wound in a roll shape is installed in the paper feed unit 3. The recording medium M in a roll shape is conveyed by the conveyance unit 5, and ink is ejected by the recording head 7 on the platen 6 to record an image. With an operation panel 2, various settings related to printing, confirmation of a print job, and the like can be performed.

The recording head 7 ejects ink from an ejection port using an ejection energy generation element such as an electrothermal conversion element (heater) or a piezoelectric element. When an electrothermal conversion element is used, heat generated by the element causes ink to bubble, and the ink can be ejected from the ejection port utilizing the bubble generating energy. The recording head 7 is not limited to an inkjet method, and the printing method is not limited and may be, for example, a serial scan method or a full-line method. In a case of the serial scan method, an image is printed along with a conveyance operation of the recording medium M and scan of the recording head 7 in the X direction intersecting the conveyance direction of the recording medium M. In a case of the full-line method, an image is printed while the recording medium M is continuously conveyed using the recording head 7 that is long extending in the X direction intersecting the conveyance direction of the recording medium M. In the present embodiment, the serial scan method will be mainly described in detail as an example.

The recording medium M on which the image is recorded is wound by the winding unit 4. When the printing operation is finished, the user may cut the recording medium with scissors or the like, but the recording medium may be cut with a cutter not illustrated.

The recovery unit 50 is disposed in the housing 54 outside an image forming region on the +X direction side of the printing apparatus 1, and maintenance by preliminary ejection or suction of the recording head 7 in the serial scanning method can be performed. The stand 8 is disposed at a position slightly outside the +X direction relative to the width of the recording medium M in order to hold the paper feed unit 3 and the winding unit 4 that are heavy while supporting the housing 54. The housing 54 is formed to protrude outward in the +X direction relative to the stand 8 in order to dispose the recovery unit 50.

A carriage motor that operates a carriage for performing scanning in the X direction with the recording head 7 mounted thereon is disposed also outside the recording medium M on the −X direction side, that is the opposite side. A conveyance motor that drives the conveyance unit 5 is also disposed. Therefore, the housing 54 protrudes slightly outward relative to the stand 8 also on the −X side to an extent not as much as the +X side where the recovery unit 50 is disposed.

Here, the liquid such as ink ejected from the recording head 7 is supplied from the liquid supply apparatus 10. Various types of liquid to be supplied are assumed, such as aqueous ink, latex ink, and solvent-based ink such as eco-solvent. They all have an issue in that the pigment component (color material) mixed with the ink is precipitated over time. For each color, the ink may be different in the particle size of the pigment, the type and amount of the additive, and the like, and, depending on the ink color, some inks may have a very high precipitation rate. It is also assumed that a reaction liquid that is ejected from the recording head 7 similarly to the ink and reacts with the ink for the purpose of fixing the ink on the surface of the recording medium M is supplied from the liquid supply apparatus 10.

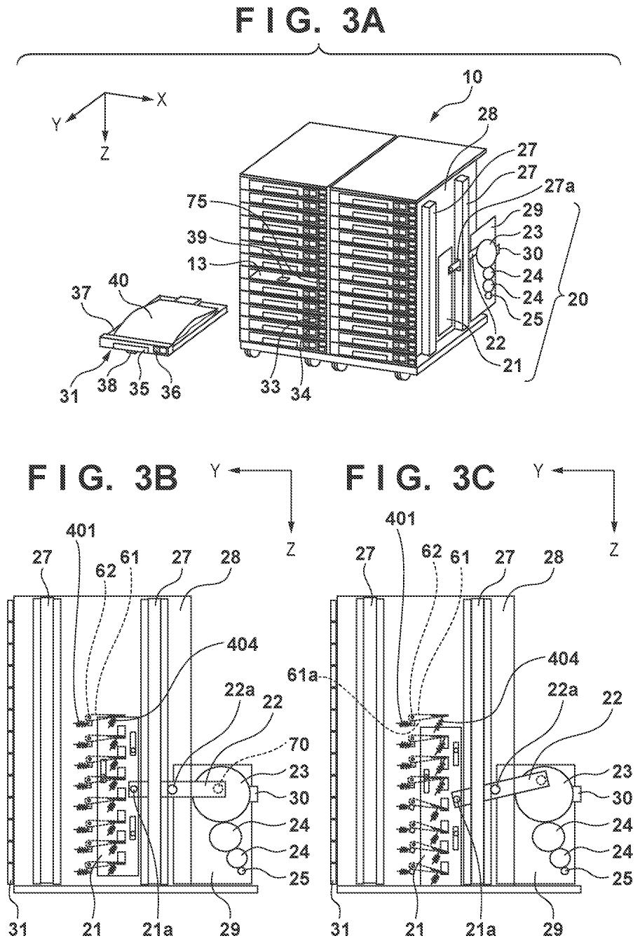

The liquid supply apparatus 10 is attached with a caster 12 similarly to the printing apparatus 1, and can move on the floor. A plurality of tray holding units 13 are disposed in the liquid supply apparatus 10, and a tank 40 (see FIGS. 3A to 3C) described later containing a liquid such as ink is set in each tray holding unit 13. A flow path formed of a flexible tube is connected to each tank (liquid container) 40, and each tube is fit in a duct hose 11. The duct hose 11 is connected from a back side of the liquid supply apparatus 10 to a back side of the printing apparatus 1, and each tube is connected to a flow path in the printing apparatus 1 and communicates with the recording head 7. In this manner, a flow path from the tank 40 to the recording head 7 is formed.

The height of the liquid supply apparatus 10 of the present embodiment is set to be lower than a lower surface of the housing 54 protruding to the +X side of the printing apparatus 1. Therefore, as in FIG. 2A, the liquid supply apparatus 10 can be fit under the housing 54. The liquid supply apparatus 10 can be brought close to a position in contact with the stand 8 in the X direction. Use of a coupling member 53 allows the liquid supply apparatus 10 to be fixed to the stand 8, and to be integrally moved when the printing apparatus 1 is moved.

When a unit having multiple tiers (plurality of tiers) of the tray holding units 13 in the Z direction is one unit, the liquid supply apparatus 10 can hold a large number of tanks 40 in the Z direction even for one unit. However, in the present embodiment, since two units are provided in the X direction, more tanks 40 can be held. In a case of increasing the number of ink colors for the purpose of high image quality or increasing the number of ink tanks of the same color for the purpose of high productivity, it is conceivable to increase the number of units to two rows and three rows in the X direction. In this case, an increase in the installation size can be suppressed by overlapping a part or the entirety of the liquid supply apparatus 10 with the printing apparatus 10 in the X direction. The liquid supply apparatus 10 having the number of tanks of only one unit can completely fit within the size of the printing apparatus 1 in the X direction. In a case of the liquid supply apparatuses 10 with two or more units, it slightly protrudes from the printing apparatus 1 in the X direction. Therefore, although details will be described later, the size of the liquid supply apparatus 10 is preferably reduced in the X direction.

In the present embodiment, a configuration in which the liquid supply apparatus 10 protrudes from the printing apparatus in the case of two units has been described. However, in a case where the size of the tank 40 in the X direction is small, or in a case where the recovery unit 50 is larger than that in the present embodiment, and the housing 54 further protrudes in the +X direction, it is conceivable that the liquid supply apparatus 10 does not protrude from the housing 54 in the X direction even in a case where the liquid supply apparatus includes a plurality of units.

In the present embodiment, a waste liquid cartridge 51 is installed on a side surface (−X side) of the printing apparatus 1 opposite to the liquid supply apparatus 10. By being installed on the lower side of the housing 54 protruding to the −X side similarly to the liquid supply apparatus 10, the waste liquid cartridge 51 can suppress an increase in the installation area of the entire apparatus. In order to cause the waste ink suctioned by the recovery unit 50 to flow to the waste liquid cartridge 51, the waste liquid cartridge 51 may be disposed near the recovery unit 50. However, in the present embodiment, the waste liquid cartridge 51 is installed at the end portion on the −X side with priority given to keeping the installation area of the entire apparatus small. The tank 40 similar to the ink tank is used as a container of a maintenance liquid used in the recovery unit 50, and is set in the liquid supply apparatus 10.

FIGS. 3A to 3C are views illustrating an external appearance of the liquid supply apparatus 10. FIG. 3A is an external perspective view of the liquid supply apparatus, FIG. 3B is a side view in a pressing release state, and FIG. 3C is a side view in a pressing state. The structure of the liquid supply apparatus 10 will be described in more detail with reference to them. The liquid supply apparatus 10 is originally surrounded by an exterior, but in FIGS. 3A to 3C illustrate the liquid supply apparatus 10, a part of which is in a state without the exterior so that the internal structure can be understood. A state in which a part of the tray 31 is pulled out is illustrated so that the relationship between the tray 31 and the tray holding unit (holding member) 13 can be understood.

The tray 31 includes a tank receiving member 37 that holds the tank 40. The user can detachably set the tray 31 with respect to the tray holding unit 13 by moving the tray 31 in the Y direction. In the set state, a projection 38 protruding from the lower surface of a tray handle 35 is engaged with a recess 39 provided in the tray holding unit 13. This prevents the tray 31 from coming off even if an operation of applying vibration to the apparatus such as movement of the liquid supply apparatus 10 is performed. In a case of removing the tray 31, a user's operation with the tray handle 35 lifts the projection 38 to be interlocked and disengages the tray 31 from the recess 39. A lock operation unit 36 is provided so that the user does not unintentionally pull out the tray 31 in the set state.

The lock operation unit 36 is installed movably in the X direction by a user's operation, and is brought into a locked state when moved to the +X side and an unlocked state when moved to the −X side. The +X side of the tray holding unit 13 is provided with a lock detection sensor 75. The lock detection sensor 75 can detect the locked state and the unlocked state based on a positional relationship with a sensor flag not illustrated coupled to the lock operation unit 36. In the locked state, the lock operation unit 36 holds the tray handle 35 in a state where the projection 38 fits into the recess 39, and therefore the projection 38 cannot be disengaged. In the unlocked state, the lock operation unit 36 does not restrict the operation of the tray handle 35. Therefore, the user can lift the projection 38 by the operation with the tray handle 35, and can pull out the tray 31.

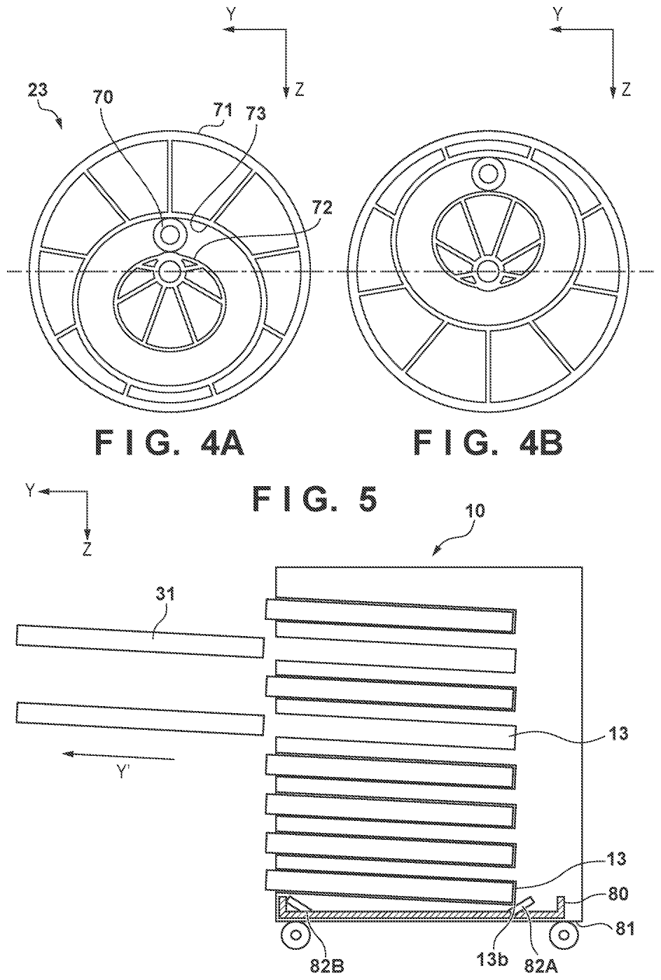

FIGS. 4A and 4B are enlarged views of the cam. Here, the configuration around a stirring drive mechanism will be described with reference to FIGS. 1 to 3A to 3C. A side surface of the liquid supply apparatus 10 is provided a stirring drive unit 20 for stirring the ink in the tank 40. Here, the configuration of the stirring drive unit 20 will be described.

The stirring drive unit 20 collectively drives a plurality of tiers of pressing plates 61 by moving a lift plate 21 up and down. A pressing portion lifting motor 25 transmits a driving force to a cam 23 via a plurality of gears 24. Gear teeth 71 of the cam 23 mesh with the gears 24, and the rotation of the gears 24 rotates the cam 23. The cam 23 has an inner cam surface 72 and an outer cam surface 73, and a cam follower 70 coupled to a drive transmission lever 22 is disposed therebetween. The inner cam surface 72 is located inside the cam follower 70 in the radial direction of the cam 23, and comes into contact with and lift the cam follower 70 when the cam 23 rotates. The outer cam surface 73 is located outside the cam follower 70 in the radial direction of the cam 23, and comes into contact with and pull down the cam follower 70 when the cam 23 rotates. A rotation detection sensor 30 that detects rotation of the cam 23 is disposed in the vicinity of the cam 23 (see FIGS. 3A to 3C). The rotation detection sensor 30 uses a photointerrupter, and is disposed such that a flag provided on the cam 23 shields the rotation detection sensor once a turn.

When the cam follower 70 moves up and down by the rotation of the cam 23, the drive transmission lever 22 turns about a turn shaft 22a. Since the drive transmission lever 22 is coupled to a lift plate shaft portion 21a provided on the lift plate (movable member) 21, the operation of the drive transmission lever 22 is converted into a lifting operation of the lift plate 21. When the cam 23 makes one rotation, the cam follower 70 makes one reciprocating operation in the lift direction, and therefore the lift plate 21 similarly makes one reciprocating lifting operation via the drive transmission lever 22.

The lift plate 21 is attached to a side plate 28 liftably in the Z direction. Two front and rear columns 27 having a U-shaped cross section extending in the Z direction are fixed to the side plate 28. This column 27 is also attached to the side plate on the −X side, and a total of four columns per unit ensure the strength as a structure. This can support the weight of the ink tank having multiple tiers.

Since the column 27 has high strength but also has a thickness, if the stirring drive unit 20 is provided on the outside on the +X side of the column 27 attached to the side plate 28, the dimension in the X direction increases. Therefore, in the present embodiment, the lift plate 21 and the drive unit such as the cam 23 are separately disposed in front and rear of the rear column 27, and the drive transmission lever 22 is disposed so as to be inserted into a through hole 27a provided in the column 27. This can dispose the stirring mechanism by suppressing the size expansion in the X direction while ensuring the strength.

Furthermore, the drive transmission lever 22 is attached to a drive holding plate 29 that supports the stirring drive unit 20, and when a fastening screw or the like is removed, the drive transmission lever 22 and the stirring drive unit 20 can be removed as an integrated unit to the back side with respect to the lift plate shaft portion 21a. Such configuration can make component replacement and the like by a service engineer easy. In particular, when a plurality of units are coupled to each other, the stirring drive unit 20 and the drive transmission lever 22 are normally not accessible unless decoupled from the adjacent unit, but if they can be removed from the back surface in this manner, maintenance work and the like become easy. In this case, a fastening screw or the like for attaching the drive holding plate 29 to the housing of the liquid supply apparatus 10 may be fastened not from the side surface but from the back surface side.

Here, a mechanism of power transmission from the lift plate 21 to the pressing plate (pressing member) 61 will be described with reference to FIGS. 3B and 3C. As described above, FIG. 3B illustrates the pressing release state, and FIG. 3C illustrates the pressing state.

The pressing plate 61 of each tier receives a load by two springs and presses the tank 40. One end of a first pressing spring 401 is latched to the pressing plate 61, and the other end is latched to the tray holding unit 13. One end of a second pressing spring 404 is latched to the pressing plate 61, and the other end is latched to the lift plate 21. The pressing plate 61 is turnably attached to the tray holding unit 13 with the turn shaft 62 as a center of turn. Both of these two springs bias the pressing plate 61 in a direction of turning the pressing plate 61 in a clockwise direction toward FIGS. 3A to 3C. When the pressing plate 61 is in the pressing release state (FIG. 3B), the lift plate 21 comes into contact with the pressing plate 61 and lifts the pressing plate 61, and a load by the second pressing spring 404 is applied between the lift plate 21 and the pressing plate 61. Therefore, the load by the second pressing spring 404 is closed between the lift plate 21 and the pressing plate 61 (becomes an internal force of the lift plate 21), and does not become a load of the stirring drive unit 20. That is, the load applied to the stirring drive unit 20 in the pressing release state is only the load of the first pressing spring 401 and the own weight of the component.

When the pressing plate 61 is in the pressing state (FIG. 3C), the cam 23 has a phase opposite by 180 degrees to that of the pressing release state, and a pressing surface 61a of the pressing plate 61 comes into contact with and presses the tank 40. In FIG. 3C, the upper four tiers illustrates a case where the tank 40 is full, and the lower four tiers illustrates a state where the tank 40 near the ink use-up is collapsed. The load of both the first pressing spring 401 and the second pressing spring 404 and the own weight of the component are given to the tank 40. At this time, the load of the first pressing spring 401 is applied to the tank 40, and is not applied to the lift plate 21. The load of the second pressing spring 404 is applied between the tank 40 and the lift plate 21 in contact with each other via the pressing plate 61. The cam 23 has an action of pulling the lift plate 21 downward with respect to the tank 40. As described above, the load applied to the stirring drive unit 20 during the operation is reduced by using the two springs having different attachment positions and the cam 23 that can both lift and lower.

In the pressing state, the expansion of the first pressing spring 401 and the second pressing spring 404 is smaller when the ink remaining amount in the tank 40 is small and the tank is collapsed, and thus the load applied to the tank 40 also becomes smaller. When the ink remaining amount in the tank 40 is large, a reaction force from the tank 40 is easily received at the time of pressing, and a large load is required for deep pressing. On the other hand, when the remaining amount is small, the reaction force from the tank 40 is small, and therefore the tank 40 is easily deformed to move the ink even if the pressing force is small. Therefore, the spring is disposed at a position where the load becomes lower as the tank is collapsed. This eliminates the need for an increase in the spring pressure more than necessary. In the present embodiment, the load applied to the pressing surface 61a is adjusted to become about 500 gf when the tank 40 is full and about 300 gf near use-up. Since the spring is disposed in each tier, even if the remaining amount of the tank 40 in each tier is different, each tank can be given an optimum pressing force.

The stirring drive unit 20 is disposed on the side surface of each unit. As illustrated in FIGS. 3A to 3C, in the case of the two-unit configuration, each unit is provided with the stirring drive unit 20, i.e., the liquid supply apparatus 10 is provided with the total of two stirring drive units 20.

FIG. 5 is an explanatory view of the tray holding unit 13 in the liquid supply apparatus 10, and is a simplified view of a Y-Z cross section as viewed from the side surface side. The tray holding unit 13 of each tier provided in the liquid supply apparatus 10 is inclined, and becomes low on the lower (+Z) side toward the back surface (−Y) side. Therefore, the tray 31 is held in an inclined manner in the set state. Although the effect will be described later, the inclination angle is desirably smaller than 45 degrees, and it is more effective that the inclination angle is 10 degrees or less with respect to the horizontal plane. In the present embodiment, the inclination angle is set to 3 degrees. An ink receiving member (liquid receiving member) 80 is disposed below the tray holding unit 13. Details of the ink receiving member 80 will be described later.

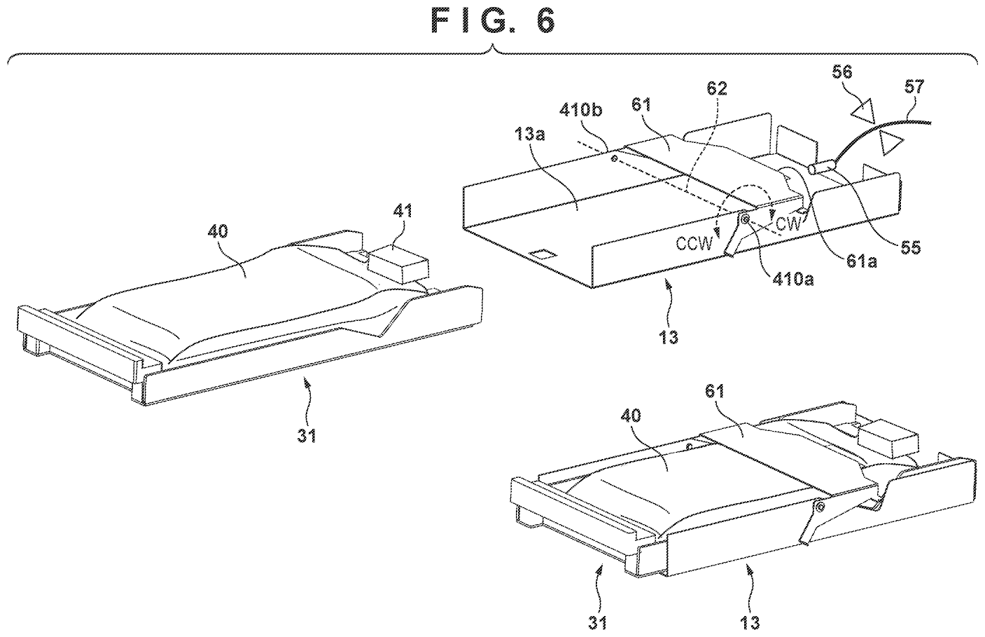

FIG. 6 is a perspective view of the tray holding unit 13, and illustrates only one tier for easy understanding of the description.

The tank 40 includes a flexible member on both upper and lower surfaces. Both side surfaces of the tank 40 are provided with gusset portions 42 folded inward in order to increase the liquid holding amount. These are welded to form a bag-shaped tank. When the liquid remaining amount inside is large, the gusset portion 42 spreads, and when it is small, the gusset portion 42 is folded, and the shape of the tank 40 changes according to the ink amount.

Usually, the tank 40 is made of a material such as PET and has a plurality of layer structures. However, when there is a concern that the liquid inside reacts with air to be retained or the concentration or the remaining amount changes due to evaporation, these are prevented by giving the flexible member a layer configuration containing an aluminum layer.

One side of the tank 40 is provided with a supply port 41, and the supply port 41 is coupled to a water intake port inside the tank. Inside the supply port 41 is provided with a spring-biased valve, the valve is released by inserting a supply needle portion 55, a liquid storage section of the tank 40 and a flow path 57 on the downstream side are coupled, and thus the liquid can be fed to the liquid supply apparatus 10. The flow path 57 is provided with a flow path valve 56, and closing and releasing of the flow path can be switched by the operation of a flow path valve switching motor. In conjunction with the detection state of the lock detection sensor 75 described above, when it is determined that the lock of the tray 31 is released in a state where the flow path is released by the flow path valve 56 such as during printing, the flow path valve 56 is closed. Doing this can prevent the tank 40 from being pulled out in a state where the flow path valve 56 is released. If the tank is pulled out in a state where the flow path valve 56 is released, air enters the flow path from the supply needle portion 55, and issues such as ink retention in the flow path 57 and ejection failure in the head 7 can occur. Therefore, the tray 31 is basically locked by the above-described lock mechanism, and the user unlocks the tray 31 when necessary, and shifts the flow path valve 58 to the closed state as necessary.

In the present embodiment, in the tank 40, the length of the side provided with the supply port 41 is about 180 mm, and the length of the side (side surface) orthogonal thereto is about 400 mm, and after the pressure is reduced in an empty state and air is sufficiently removed, about 1.5 L of ink is injected. In the present embodiment, the side provided with the supply port 41 is a short direction, but a form in which the side provided with the supply port 41 is a long direction or a length of a side orthogonal to the side provided with the supply port 41 is equal is also conceivable.

On one side of the tray holding unit 13, the supply needle portion 55 provided with a hole communicating with the flow path 57 in the vicinity of a tip end is disposed. The tray holding unit 13 is provided with the pressing plate 61. The pressing plate 61 is biased in a direction in which the −Y side is lowered by a spring pressure about the turn shaft 62.

As another configuration, a configuration in which when the pressing plate 61 is installed on the tray 31 and the tray 31 is set on the tray holding unit 13, a driving force is transmitted up to the pressing plate 61, and a pressing operation is enabled is also conceivable. Even with this configuration, a similar stirring effect can be obtained, this configuration may be adopted. However, when the tank 40 is set on the tray 31, it is necessary to avoid the pressing plate 61, and operability is slightly deteriorated. Therefore, the configuration in which the pressing plate 61 is disposed in the tray holding unit 13 has better operability.

The pressing plate 61 is formed of a metal steel plate. As compared with a member made of resin or the like, the strength is high even if the thickness is thin, and therefore the height of the tray holding unit 13 can be suppressed. The turn shaft 62 of the pressing plate 61 is disposed outside relative to the tank 40 in the X direction, and is provided at a position overlapping the tank in a direction perpendicular to a holding surface 13a of the tray holding unit 13 when the tank 40 is full. By the devise of suppressing the size in the Z direction, even if the pressing plate 61 is installed in the tray holding unit 13 of each tier to have the stirring function, the tank 40 of the multiple tiers can be fit in a limited space below the housing of the printing apparatus 1.

The pressing surface 61a of the pressing plate 61 has a dimension in the X direction set to be smaller than the dimension near the turn shaft 62 of the pressing plate 61. This is because the pressing plate 61 is prevented from coming into contact with an unpressed part of the tank 40 to damage the tank 40 when the pressing plate 61 turns and the pressing surface 61a presses the tank 40. Even if burr at an edge part is removed, the metal steel plate may damage the tank 40 when repeatedly coming into contact with the bag-shaped tank 40. Therefore, it is considered not to make such contact.

The position of the pressing surface 61a in the X direction has another characteristic. The tank 40 is provided with the gusset portion 42 on the side surface as described above. This gusset portion 42 includes a welded part between the flexible members and has higher rigidity than other parts. In order to deform the tank 40 by pressing, it is necessary to fold the gusset portion 42 inward, and a pressing force therefor is required. Furthermore, in a state where the ink remaining amount in the tank 40 is large, the gusset portion 42 is expanded in the top-bottom direction, and the gusset portion 42 may bulge not inward but outward. In such a state, a large pressing force is needed to crush the gusset portion 42. For these reasons, in order to efficiently press and deform the tank 40 for stirring, it is desirable to dispose the pressing surface 61a inside in the X direction relative to the gusset portion 42.

The gusset portion 42 in the present embodiment has a width in the X direction in a state where both side surfaces are folded is about 20 mm on one side. Since the pressing surface 61a is located inside relative to the gusset portions 42 on both side surfaces, the reaction force of the gusset portions 42 is hardly received, and the tank 40 can be efficiently pressed. According to a verification result with an actual machine, the pressing efficiency is further improved when the size is adjusted to a size that fits 10 mm or more inside relative to the gusset portions 42 on both side surfaces. This is because even if the pressing surface 61a is on the inner side of the tank 40 relative to the gusset portion 42, the reaction force of the gusset portion 42 is slightly received in a region close to the gusset portion 42, but the influence of the reaction force of the gusset portion 42 is further reduced on the further inside.

When the X direction size of the pressing surface 61a is minimized, the pressing surface may have a shape that comes into point contact with the tank 40. However, as in the tank 40 of the present embodiment, when the side surface of the tank 40 coincides with the long direction when viewed from the supply port 41, it is preferable to flow a large amount of ink in the long direction because the entire tank 40 is stirred. Here, as illustrated in FIG. 5, it is assumed that a direction parallel to the inclination angle direction of the tank 40 is a Y′ direction, the supply port 41 side in the tank 40 is a −Y′ direction, and the opposite direction is a +Y′ direction.

When the X direction size of the pressing surface 61a is small, movement of the ink by an amount pushed by pressing of the tank 40 is dispersed also to the outside in the X direction, and therefore the ink movement amount to the Y′ direction is reduced accordingly. According to the experimental result, when the pressing surface 61a has a size of ⅓ or greater of the X direction size of the tank 40, the ink movement amount at the time of pressing becomes larger in the Y′ direction than in the X direction, which is more desirable. Since the tank 40 of the present embodiment has a dimension of 180 mm in the X direction, the width of the pressing surface 61a is desirably 60 mm or more.

To summarize the above, in a case of a tank having a width of 180 mm and having the gusset portions 42 formed by 20 mm at both ends, the X direction dimension of the pressing surface 61a is preferably set to be between 60 mm and 120 mm. In the present embodiment, the X direction dimension of the pressing surface 61a is set to be 90 mm.

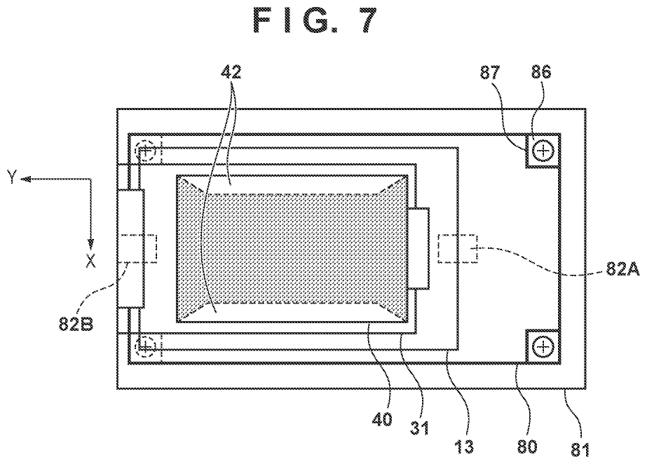

Next, the ink receiving member (liquid receiving member) 80 of the present embodiment will be described in detail. FIG. 7 is a plan view illustrating the configuration of the ink receiving member 80.

As illustrated in FIGS. 5 and 7, the ink receiving member 80 is provided at a bottom part of the liquid supply apparatus 10. The ink receiving member 80 is installed horizontally with respect to a bottom plate 81 of the liquid supply apparatus 10. The ink receiving member 80 is formed in a box shape with a resin member or the like so as to receive the ink leaking from the tank 40 and store the received ink without leaking. In the present embodiment, the volume allowing the ink of the ink receiving member 80 to be received is set to the volume of one or more tanks 40, and the height of a side wall of the ink receiving member 80 is set to be a height that enables the same. The ink receiving member 80 and the bottom plate 81 are fixed by screws 86 at four corners, and a side wall 87 is formed so as to surround the outside of a screw hole so that ink does not enter the screw hole of the screw 86.

Here, as described above, since the tray holding unit 13 is inclined and becomes low on the lower (+Z) side toward the back surface (−Y) side, the tray 31 is held in an inclined manner in the set state. That is, the angles of the bottom surfaces of the ink receiving member 80 and the tray holding unit 13 are different. More specifically, the inclination of the bottom surface of the tray holding unit 13 is set to be steeper than the inclination of the bottom surface of the ink receiving member 80. Due to this, in a case where the ink leaks from the tank 40, the ink goes along each inclined tray holding unit 13 and gathers at each lowest part 13b (see FIG. 5) of the tray holding unit 13. Then, the ink dripping therefrom can be received by the ink receiving member 80, and leakage of the ink to the outside of the liquid supply apparatus 10 can be prevented.

As illustrated in FIG. 5, the height of the upper end of the side wall of the ink receiving member 80 is set to be higher than the lowest part 13b of the tray holding unit 13. This causes the ink receiving member 80 and the tray holding unit 13 to overlap in the Z direction, and can suppress the height of the liquid supply apparatus 10 low. In the present embodiment, the ink receiving member 80 and the tray holding unit 13 overlap such that the height of the liquid supply apparatus 10 becomes about the same as the height when the tray holding unit 13 is set horizontally. At least a part of the width in the X direction (planar direction) of the ink receiving member 80 is larger than the width in the X direction of the tray holding unit 13. Similarly, at least a part of the width in the Y direction (planar direction) of the ink receiving member 80 is larger than the width in the Y direction of the tray holding unit 13. Thus, whether the ink is actually accumulated in the ink receiving member 80 can be visually confirmed.

Next, ink detection sensors (liquid detection sensors) 82A and 82B will be described. The ink detection sensors 82A and 82B are disposed on the front side and the rear side (front and rear in the Y direction) of the apparatus inside the ink receiving member 80. The ink detection sensors 82A and 82B are configured by a pair of electrode terminals, and can detect whether or not the electric resistance between the electrode terminals changes according to the amount of ink adhered between the electrode terminals and whether or not the ink is adhered. As other examples of ink detection means, a transmissive sensor, a reflective sensor, and a distance sensor can also be used.

The ink detection sensor 82A is disposed in the vicinity immediately below the lowest part 13b of the tray holding unit 13. Doing this makes it possible to detect, with the ink detection sensor 82A, the ink going along the tray holding unit 13 and gathering and dripping at the lowest part 13b at an early stage. The ink detection sensor 82B is provided in the vicinity immediately below the inlet of the tank 40. This enables early detection of leakage of the ink even when the installation angle of the apparatus becomes larger than the inclination of the tray holding unit 13 and the leaked ink gathers on the inlet (+Y) side of the tank 40.

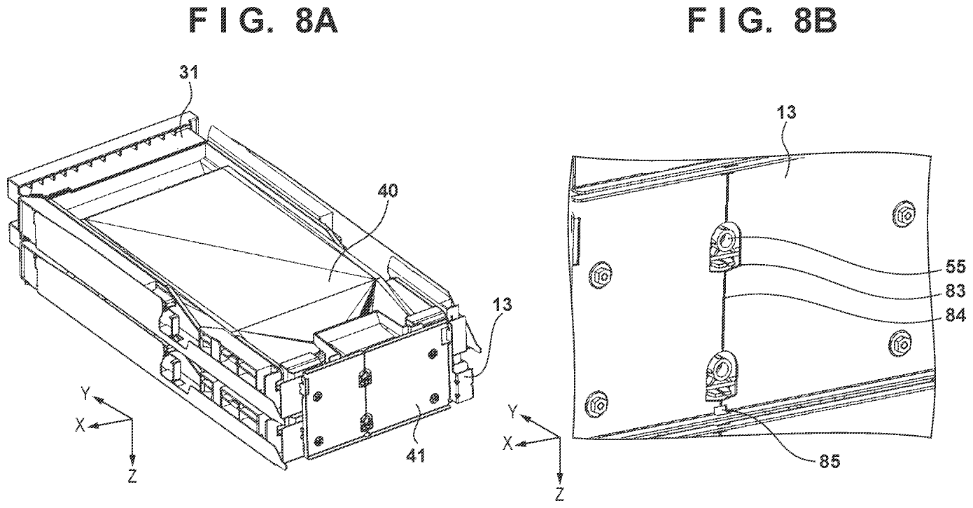

Next, a guide path of the leaked ink will be described with reference to FIGS. 8A and 8B. FIG. 8A is a perspective view illustrating the periphery of the tray holding unit 13, and FIG. 8B is an enlarged view of the back side (−Y side) of the tray holding unit 13.

As illustrated in FIG. 8B, a cutout hole 83 for connecting, to the flow path valve 56 (see FIG. 6), the supply needle portion 55 for supplying ink is formed on an abutment surface of the tank 40 of the tray holding unit 13. Then, a guide groove 84 is formed up and down in the Z direction of the cutout hole 83. A guide hole 85 is formed at the lowermost part of the abutment surface. According to this configuration, the ink leaking from the tank 40 or near the supply needle portion 55 enters the cutout hole 83 and drips downward in the Z direction along the guide groove 84. The dripped ink enters the guide hole 85 and goes toward the tray holding unit 13 of the lower tier. This can guide the ink downward in the Z direction even if the ink leaks from anywhere in the tray holding unit 13 overlapping in a plurality of tiers, and can detect the ink leakage by any of the ink detection sensors 82A and 82B.

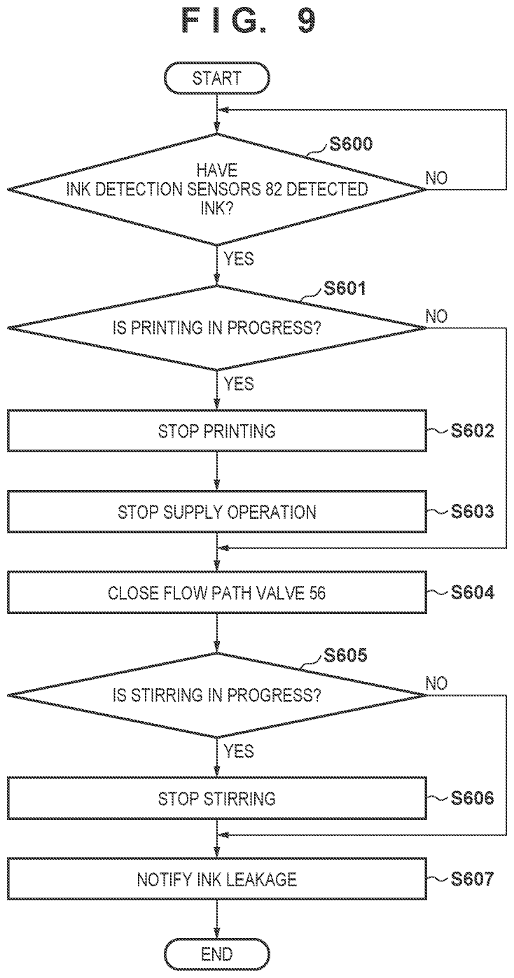

Next, the operation of the liquid supply apparatus 10 when ink leakage is detected by the ink detection sensors 82A and 82B will be described with reference to the flowchart of FIG. 9. The operation of the flowchart of FIG. 9 is implemented by a control unit not illustrated of the liquid supply apparatus 10 executing a program stored in a storage unit.

In step S600, the control unit of the liquid supply apparatus 10 determines whether or not any of the ink detection sensors 82A and 82B has detected ink. The control unit of the liquid supply apparatus 10 advances the processing to step S601 if the ink is detected, and repeats the processing of step S600 if the ink is not detected.

When the ink is detected in step S600, there is a possibility that the ink is leaking from an unexpected site of the apparatus. Therefore, in step S601, the control unit of the liquid supply apparatus 10 determines whether or not the printing apparatus 1 is in progress of print processing. If printing is being performed, the control unit of the liquid supply apparatus 10 advances the processing to step S602, and if not, the control unit advances the processing to step S604.

In step S602, the control unit of the liquid supply apparatus 10 notifies the printing apparatus 1 to cause it to stop printing. Furthermore, in step S603, the ink supply operation is stopped.

In step S604, the control unit of the liquid supply apparatus 10 closes the flow path valve 56 to block the flow path of the ink from the tank 40 to a body of the liquid supply apparatus 10.

In step S605, the control unit of the liquid supply apparatus 10 determines whether or not the ink is being stirred. The control unit of the liquid supply apparatus 10 advances the processing to step S606 if the ink is being stirred, and advances the processing to step S607 otherwise.

In step S606, the control unit of the liquid supply apparatus 10 stops the stirring of the ink.

In step S607, using an operation panel not illustrated or the like, the control unit of the liquid supply apparatus 10 notifies the user that ink leakage has occurred. As notification means, other than display by the operation panel, notification by a lamp, notification by a buzzer, notification on PC software, or the like may be used.

As described above, according to the present embodiment, by providing the bottom part of the liquid supply apparatus 10 with the ink receiving member 80, it is possible to prevent the leakage of the ink to the outside of the liquid supply apparatus 10. It becomes possible to reliably notify the user of the occurrence of ink leakage and call attention.

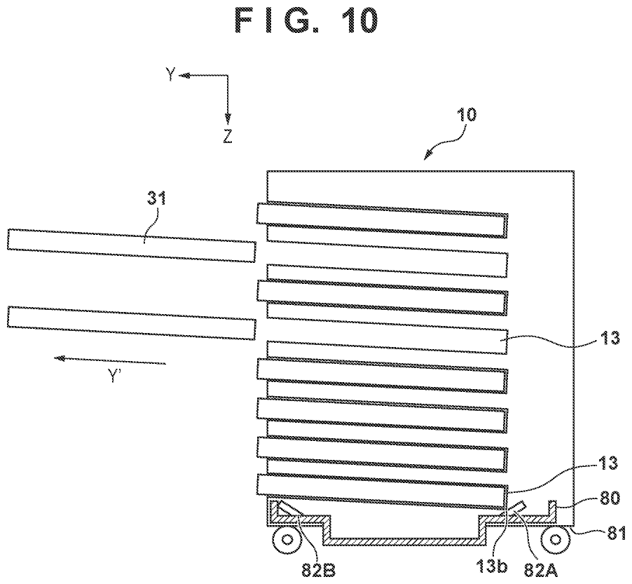

In the present embodiment, the entire ink receiving member 80 is disposed on the upper side of the bottom plate 81 of the liquid supply apparatus 10, but as illustrated in FIG. 10, a part of the bottom plate 81 may be cut out, and a part of the ink receiving member 80 may fit into it. This can further increase the volume of receiving the ink by the ink receiving member 80, and can further improve the effect of reduction in the apparatus size and reduction in the risk of ink leakage.

It is also possible to further reduce the risk of ink leakage by disposing an absorber that absorbs liquid inside the ink receiving member 80 and absorbing and holding the leaked ink.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-074955, filed Apr. 28, 2023, which is hereby incorporated by reference herein in its entirety.

What is claimed is:

1. A liquid supply apparatus comprising:
a holding member configured to detachably hold a tray on which a container, that is flexible and is provided with a supply port for supplying liquid to a recording head, is placed with respect to the liquid supply apparatus; and
a receiving member that is provided below the holding member attached to the liquid supply apparatus and is configured to receive a liquid leaking from the container,
wherein an angle of a bottom surface of the holding member with respect to a horizontal plane is different from an angle of a bottom surface of the receiving member with respect to the horizontal plane.

2. The liquid supply apparatus according to claim 1, wherein an inclination angle of the bottom surface of the holding member with respect to the horizontal plane is larger than an inclination angle of the bottom surface of the receiving member with respect to the horizontal plane.

3. The liquid supply apparatus according to claim 1, wherein the bottom surface of the holding member is inclined with respect to the horizontal plane such that the supply port is downward.

4. The liquid supply apparatus according to claim 1, wherein a height of an upper end of a side wall of the receiving member is higher than a height of a lowest part of the bottom surface of the holding member.

5. The liquid supply apparatus according to claim 1, wherein at least a part of a width in a planar direction of the receiving member is larger than a width in a planar direction of the holding member.

6. The liquid supply apparatus according to claim 1, wherein a volume allowing a liquid of the receiving member to be received is set to be equal to or greater than a volume per one of the container.

7. The liquid supply apparatus according to claim 1, wherein the holding member has a guide path configured to guide liquid toward the receiving member.

8. The liquid supply apparatus according to claim 1 further comprising a detection sensor that is disposed in the receiving member and detects liquid.

9. The liquid supply apparatus according to claim 8, wherein the tray on which the container is placed is attached by being inserted into the holding member in a first direction of the receiving member, and the detection sensor is provided on a front side and a rear side in the first direction of the receiving member.

10. The liquid supply apparatus according to claim 8, wherein the detection sensor is disposed in a vicinity immediately below a lowest part of the bottom surface of the holding member.

11. The liquid supply apparatus according to claim 8, further comprising a notification device configured to notify that the detection sensor has detected liquid.

12. The liquid supply apparatus according to claim 1, wherein the liquid is ink for performing recording with the recording head.
